(19) United States
(12) Patent Application Publication
(10) Pub. No.: US 2018/0010073 A1
(43) Pub. Date: Jan. 11, 2018

(54) DRYING-AID FOR LAUNDRY

(71) Applicant: Diversey, Inc., Sturtevant, WI (US)

(72) Inventors: Anant Parte, Mumbai (IN); Niels Johannes Maria Pijnenburg, Rosmalen (NL); Parag Ashokrao Wasekar, Sawangi (meghe), District Wardha (IN); Sumedh Sanjay Ganu, Mumbai (IN); Yashesh Prafull Lodaya, Bhandup (West), Mumbai (IN)

(21) Appl. No.: 15/544,858

(22) PCT Filed: Jan. 15, 2016
(86) PCT No.: PCT/US16/13598

§ 371 Date: Jul. 19, 2017

Related U.S. Application Data
(60) Provisional application No. 62/104,929, filed on Jan. 19, 2015.

(51) Int. Cl. C11D 3/37; C11D 11/00; D06M 15/53; D06M 15/643

(52) U.S. Cl. CPC C11D 3/3707; D06M 15/6436; C11D 3/3742; C11D 11/0017; D06M 15/53

(57) ABSTRACT

Provided are drying aid compositions, which comprise an ethylene oxide-propylene oxide-ethylene oxide (EO/PO/EO) triblock copolymer and an aminosilicone. The compositions can be added to the aqueous bath during the laundry process to reduce the drying time of a textile. Also provided is a process for laundering a textile, which comprises contacting the textile with an aqueous bath containing a drying aid composition comprising an ethylene oxide-propylene oxide-ethylene oxide (EO/PO/EO) triblock copolymer and an aminosilicone.

### CROSS-REFERENCE TO RELATED APPLICATION

This application claims the benefit of and priority to U.S. Provisional Patent Application No. 62/104,929, filed Jan. 19, 2015, the entire content of which is hereby incorporated by reference.

### BACKGROUND

Drying operations can be one of the primary bottlenecks in an industrial laundry operation if not performed efficiently. Further, drying operations consume upwards of 65% of the total energy consumed in a laundering process.

According to the Textile Rental Service Association of America, the total in-plant energy used for laundering textiles has steadily declined from about 3100 Btu per pound of laundry in 1997 to about 2260 Btu per pound of laundry in 2009. See LaundryESP® by TRSA, http://www.trsa.org/page/energy (last visited Mar. 1, 2013). Similarly, water usage for laundering textiles has steadily declined from about 2.31 gallons per pound of laundry in 1997 to about 1.55 gallons per pound of laundry in 2009. See LaundryESP® by TRSA, http://www.trsa.org/page/water (last visited Mar. 1, 2013). A significant portion of these efficiency gains can be attributed to systems that provide mechanical advantages to the drying process and incorporate recycling of heat and water.

Drying of laundry is generally a two-stage process: mechanical dewatering followed by thermal drying. A textile going through this process will have some initial moisture content and will undergo mechanical dewatering for some time until an intermediate moisture content is reached. Once this occurs, the textile having an intermediate moisture content will undergo thermal drying for some time until a final moisture content is reached. In both stages, the energy consumption can be reduced by either reducing the moisture content at the beginning of the stage or improving moisture removal efficiency during the stage. However, there exist only a few means of achieving these reductions and improvements.

First, the water-removal process may be improved, such that moisture removal is more efficient regardless of the textile or water used. These improvements can be made by improving the mechanical efficiency of the process, incorporating recycling of heat and water, or simply by taking advantage of components which themselves have higher energy efficiency, such as energy efficient motors and the like. Improvements to the process are generally applicable to any type of textile, and therefore result in energy savings regardless of the textile used. Reduction in energy related to improvement in the water-removal process may translate into a reduction in cost of laundering a textile only after the cost of the equipment required for the improved process has been repaid. In other words, a significant up-front investment must be made in order to achieve the benefits of improved mechanical extraction, so the savings are delayed. Furthermore, improvements to the process require a process that is not already state-of-the-art, so they are not effective to reduce energy costs for newer laundry processes.

Second, a textile may be chemically modified so as to retain less water than it otherwise would in the absence of the chemical modification. Examples of chemically-modified textiles having improved drying properties can be found in U.S. Patent Application Pub. No. 2009/0158492, which is incorporated herein by reference in its entirety. While chemically modifying textiles can lead to energy savings associated with drying processes, improvements in overall laundering efficiency must take into account the costs associated with chemically modifying existing normal textiles or replacing existing normal textiles with chemically-modified textiles. A significant up-front investment thus must be made in order to achieve the benefits associated with chemically-modified textiles, thereby delaying overall savings.

Third, a composition may be added to an aqueous bath at some point during the laundering process to modify the interaction between water and the textile, such that the textile does not retain as much water as it otherwise would if the same laundering process were performed without the composition. Reductions in energy related to adding compositions to an aqueous bath are generally applicable to any type of textile, and therefore result in energy savings regardless of the textile used or the details of the extraction and drying process. While using compositions to reduce the drying time of textiles can lead to energy savings associated with the drying process, improvements in overall laundering efficiency must take into account the costs associated with the use of the composition. However, unlike the means discussed above, the up-front cost associated with adding a composition to an aqueous bath are minimal, as one needs to only purchase as much composition as one intends to use. When reduction in energy occurs as a result of adding a composition to an aqueous bath, the reduction of cost is immediate and occurs with every load of laundry, so the savings are not delayed like the means discussed above.

In discussions of laundry efficiency, emphasis is routinely placed on the first and second means of improvement (improved mechanical extraction and chemically-modifying textiles, respectively), without mentioning the possibility of the third means, namely, adding a composition to an aqueous bath. See, e.g., “Saving Money in the Laundry Room: Conserving time, energy and dollars” by Mike Bagg, American Laundry News, Oct. 2, 2012, http://www.americanlaundrynews.com/article/saving-money-laundry-room (last visited Mar. 1, 2013); and “Panel of Experts: Boosting Laundry Energy Efficiency and Water Conservation,” American Laundry News, Apr. 17-18, 2012, Part 1 (http://www.americanlaundrynews.com/article/panel-experts-boosting-laundry-energy-efficiency-and-water-conservation-part-1-2) and Part 2 (http://www.americanlaundrynews.com/article/panel-experts-boosting-laundry-energy-efficiency-and-water-conservation-part-2-2) (both last vi sited Mar. 1, 2013).

Accordingly, a need exists for a drying-aid for a laundry process that is capable of reducing the drying time of a textile at a cost low enough that the energy savings translate into cost reduction, without the up-front costs associated with the equipment required to achieve improved mechanical extraction or chemical modification of textiles.

### SUMMARY

In one aspect, the present disclosure provides a drying aid composition for reducing a drying time of a textile after immersion in an aqueous bath by adding the composition to the aqueous bath, the composition comprising an ethylene oxide-propylene oxide-ethylene oxide (EO/PO/EO) triblock copolymer and an aminosilicone. In another aspect, the present disclosure provides a method of lowering a cost of laundering a textile, the method comprising contacting the textile with an aqueous bath containing a drying aid composition, which comprises an ethylene oxide-propylene oxide-ethylene oxide (EO/PO/EO) triblock copolymer; and an aminosilicone.

Other aspects of the invention will become apparent by consideration of the detailed description and accompanying drawings.

### BRIEF DESCRIPTION OF THE DRAWINGS

FIG. 1 is a plot of the data acquired in Example 4, graphing the percent reduction in drying time versus the dosage of drying-aid composition.

### DETAILED DESCRIPTION

This disclosure is not limited in its application to the details of construction and the arrangement of components set forth in the following description. The disclosure may provide other embodiments and may be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

It should be understood that, as used herein, the term “about” is synonymous with the term “approximately.” Illustratively, the use of the term “about” indicates that a value includes values slightly outside the cited values. Variation may be due to conditions such as experimental error, manufacturing tolerances, variations in equilibrium conditions, and the like. In some embodiments, the term “about” includes the cited value plus or minus 10%. In all cases, where the term “about” has been used to describe a value, it should be appreciated that this disclosure also supports the exact value.

This disclosure provides compositions, uses of compositions, methods of lowering a cost of drying a textile, and processes for drying a textile, as described in detail below.

### I. Compositions

This disclosure provides compositions for reducing a drying time of a textile after immersion in an aqueous bath by adding the composition to the aqueous bath. The compositions may comprise an ethylene oxide-propylene oxide-ethylene oxide (EO/PO/EO) triblock copolymer and an aminosilicone. In one aspect, the composition is a stable formulation which contains an EO/PO/EO triblock copolymer and an aminosilicone.

It has been observed that adding a composition comprising either an EO/PO/EO triblock copolymer or an aminosilicone to an aqueous bath containing a textile causes an overall reduction in the drying time of the textile. Moreover, it was surprisingly discovered that compositions comprising both an EO/PO/EO triblock copolymer and an aminosilicone, when added to an aqueous bath containing a textile, reduce the drying time of the textile more so than compositions comprising either the EO/PO/EO triblock copolymer alone, or the aminosilicone alone. In other words, the EO/PO/EO triblock copolymer and aminosilicone, when provided together in a single composition appear to have a synergistic effect on the efficiency of the drying process.

The amount of EO/PO/EO triblock copolymer (by weight of the active ingredient) in the composition may be at least about 5%, such as at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95%. The amount of EO/PO/EO triblock copolymer (by weight) in the composition may be at most about 99%, such as at most about 95%, at most about 90%, at most about 85%, at most about 80%, at most about 75%, at most about 70%, at most about 65%, at most about 60%, at most about 55%, at most about 50%, at most about 45%, at most about 40%, at most about 35%, at most about 30%, at most about 25%, at most about 20%, at most about 15%, or at most about 10%. This includes embodiments where the amount of EO/PO/EO triblock copolymer (by weight) in the composition ranges from about 5% to about 95% including, but not limited to, amounts ranging from about 10% to about 90%, from about 15% to about 85%, from about 20% to about 80%, and from about 25% to about 75%.

The amount of aminosilicone (by weight of the active ingredient) in the composition may be at least about 1%, such as at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, or at least about 24%. The amount of aminosilicone (by weight) in the composition may be at most about 25%, such as at most about 24%, at most about 23%, at most about 22%, at most about 21%, at most about 20%, at most about 19%, at most about 18%, at most about 17%, at most about 16%, at most about 15%, at most about 14%, at most about 13%, at most about 12%, at most about 11%, at most about 10%, at most about 9%, at most about 8%, at most about 7%, at most about 6%, at most about 5%, at most about 4%, at most about 3%, or at most about 2%. This includes embodiments where the amount of aminosilicone (by weight) in the composition ranges from about 1% to about 25% including, but not limited to, amounts ranging from about 2% to about 24%, from about 3% to about 23%, from about 4% to about 22%, from about 5% to about 21%, from about 6% to about 20%, from about 7% to about 19%, from about 8% to about 18%, from about 9% to about 17%, and from about 10% to about 16%.

The compositions disclosed herein may comprise a ratio (by weight of the active ingredients) of EO/PO/EO triblock copolymer to aminosilicone of at least about 0.2:1, such as at least about 0.4:1, at least about 1:1, at least about 1.5:1, at least about 2:1, at least about 2.5:1, such as at least about 3:1, at least about 3.5:1, at least about 4:1, at least about 4.5:1, at least about 5:1, at least about 5.5:1, at least about 6:1, at least about 6.5:1, at least about 7:1, at least about 7.5:1, at least about 8:1, at least about 8.5:1, at least about 9:1, at least about 9.5:1, at least about 10:1, at least about 10.5:1, at least about 11:1, at least about 11.5:1, at least about 12:1, at least about 12.5:1, at least about 13:1, at least about 13.5:1, at least about 14:1, at least about 14.5:1, at least about 15:1, at least about 15.5:1, at least about 16:1, at least about 16.5:1, at least about 17:1, at least about 17.5:1, at least about 18:1, at least about 18.5:1, at least about 19:1, at least about 19.5:1, at least about 20:1, at least about 21:1, at least about 22:1, at least about 23:1, at least about 24:1, at least about 25:1, at least about 30:1, at least about 35:1, at least about 40:1, or at least about 45:1. The compositions disclosed herein may comprise a ratio (by weight) of EO/PO/EO block copolymer to aminosilicone of at most about 50:1, such as at most about 45:1, at most about 40:1, at most about 35:1, at most about 30:1, at most about 25:1, at most about 24:1, at most about 23:1, at most about 22:1, at most about 21:1, at most about 20:1, at most about 19.5:1, at most about 19:1, at most about 18.5:1, at most about 18:1, at most about 17.5:1, at most about 17:1, at most about 16.5:1, at most about 16:1, at most about 15.5:1, at most about 15:1, at most about 14.5:1, at most about 14:1, at most about 13.5:1, at most about 13:1, at most about 12.5:1, at most about 12:1, at most about 11.5:1, at most about 11:1, at most about 10.5:1, at most about 10:1, at most about 9.5:1, at most about 9:1, at most about 8.5:1, at most about 8:1, at most about 7.5:1, at most about 7:1, at most about 6.5:1, at most about 6:1, at most about 5.5:1, at most about 5:1, at most about 4.5:1, at most about 4:1, at most about 3.5:1, at most about 3:1; at most about 2.5:1, at most about 2:1, at most about 1.5:1, about most about 1:1, or at most about 0.4:1. This includes embodiments where the ratio (by weight) of EO/PO/EO block copolymer to aminosilicone in the composition ranges from about 0.2:1 to about 50:1 including, but not limited to, ratios ranging from about 1:1 to about 40:1, from about 2:1 to about 25:1, from about 5:1 to about 15:1, from about 5.5:1 to about 14.5:1, from about 6:1 to about 14:1, from about 6.5:1 to about 13.5:1, from about 7:1 to about 13:1, from about 7.5:1 to about 12.5:1, from about 8:1 to about 12:1, from about 8.5:1 to about 11.5:1, and from about 9:1 to about 11:1.

In some embodiments, the composition further may comprise one or more fabric softeners. Fabric softeners may include one or more components, including at least one fabric softener active component that functions to soften textiles. Suitable fabric softeners may include, but are not limited to those disclosed in U.S. Patent Publication Nos. 2006/0089293, 2006/0264352, 2009/0203570, and 2012/0324652, and U.S. Pat. Nos. 3,972,131, 4,035,307, 4,661,267, 5,002,681, 5,500,138, 5,726,144, 5,977,055, 6,492,322, 6,583,105, 6,939,844, and 7,381,697, among others. Use of a fabric softener in compositions disclosed herein, may provide ease of use, such that a single composition can be introduced into the laundering process in the same fashion as the fabric softener is currently introduced.

In embodiments comprising a fabric softener, the compositions disclosed herein may comprise a ratio (by weight of the active ingredients) of EO/PO/EO block copolymer and aminosilicone combined to fabric softener of at least about 1:10, such as at least about 1:9, at least about 1:8, at least about 1:7, at least about 1:6, at least about 1:5, at least about 1:4, at least about 1:3, or at least about 1:2. The compositions disclosed herein may comprise a ratio (by weight) of EO/PO/EO block copolymer and aminosilicone combined to fabric softener (as 100% active) of at most about 1:1, such as at most about 1:2, at most about 1:3, at most about 1:4, at most about 1:5, at most about 1:6, at most about 1:7, at most about 1:8, or at most about 1:9. This includes, but is not limited to embodiments where the ratio (by weight) of EO/PO/EO block copolymer and aminosilicone combined to fabric softener (as 100% active) ranges from about 1:10 to about 1:1, including, but not limited to, ratios ranging from about 1:8 to about 1:3, and from about 1:7.5 to about 1:4.

In some embodiments, the compositions disclosed herein are added to an aqueous bath to yield a combined amount of EO/PO/EO block copolymer and aminosilicone in the aqueous bath of at least about 0.1 g per kg of textile, such as at least about 0.2 g, at least about 0.3 g, at least about 0.4 g, at least about 0.5 g, at least about 0.6 g, at least about 0.7 g, at least about 0.8 g, at least about 0.9 g, at least about 1.0 g, at least about 1.1 g, at least about 1.2 g, at least about 1.3 g, at least about 1.4 g, at least about 1.5 g, at least about 1.6 g, at least about 1.7 g, at least about 1.8 g, at least about 1.9 g, at least about 2.0 g, at least about 2.1 g, at least about 2.2 g, at least about 2.3 g, at least about 2.4 g, at least about 2.5 g, at least about 2.6 g, at least about 2.7 g, at least about 2.8 g, at least about 2.9 g, at least about 3.0 g, at least about 3.1 g, at least about 3.2 g, at least about 3.3 g, at least about 3.4 g, at least about 3.5 g, at least about 3.6 g, at least about 3.7 g, at least about 3.8 g, at least about 3.9 g, at least about 4.0 g, at least about 4.1 g, at least about 4.2 g, at least about 4.3 g, at least about 4.4 g, at least about 4.5 g, at least about 4.6 g, at least about 4.7 g, at least about 4.8 g, at least about 4.9 g, at least about 5.0 g, at least about 5.5 g, at least about 6.0 g, at least about 6.5 g, at least about 7.0 g, at least about 7.5 g, at least about 8.0 g, at least about 8.5 g, at least about 9.0 g, or at least about 9.5 g per kg of textile. When added to an aqueous bath, the compositions disclosed herein may yield a combined amount of EO/PO/EO block copolymer and aminosilicone in the aqueous bath of at most about 10.0 g per kg of textile, such as at most about 9.5 g, at most about 9.0 g, at most about 8.5 g, at most about 8.0 g, at most about 7.5 g, at most about 7.0 g, at most about 6.5 g, at most about 6.0 g, at most about 5.5 g, at most about 5.0 g, at most about 4.9 g, at most about 4.8 g, at most about 4.7 g, at most about 4.6 g, at most about 4.5 g, at most about 4.4 g, at most about 4.3 g, at most about 4.2 g, at most about 4.1 g, at most about 4.0 g, at most about 3.9 g, at most about 3.8 g, at most about 3.7 g, at most about 3.6 g, at most about 3.5 g, at most about 3.4 g, at most about 3.3 g, at most about 3.2 g, at most about 3.1 g, at most about 3.0 g, at most about 2.9 g, at most about 2.8 g, at most about 2.7 g, at most about 2.6 g, at most about 2.5 g, at most about 2.4 g, at most about 2.3 g, at most about 2.2 g, at most about 2.1 g, at most about 2.0 g, at most about 1.9 g, at most about 1.8 g, at most about 1.7 g, at most about 1.6 g, at most about 1.5 g, at most about 1.4 g, at most about 1.3 g, at most about 1.2 g, at most about 1.1 g, at most about 1.0 g, at most about 0.9 g, at most about 0.8 g, at most about 0.7 g, at most about 0.6 g, at most about 0.5 g, at most about 0.4 g, at most about 0.3 g, or at most about 0.2 g per kg of textile. This includes embodiments where adding the composition to the aqueous bath yields a combined amount of EO/PO/EO triblock copolymer and aminosilicone in the aqueous bath ranging from about 0.1 g per kg of textile to about 10.0 g per kg of textile, including, but not limited to, amounts ranging from about 0.5 g per kg of textile to about 5.0 g per kg of textile, from about 0.75 g per kg of textile to about 4.0 g per kg of textile, and from about 1.0 g per kg of textile to about 3.0 g per kg of textile.

When added to an aqueous bath, the compositions disclosed herein may yield an amount of EO/PO/EO triblock copolymer in the aqueous bath of at least about 0.05 g per kg of textile, such as at least about 0.1 g, at least about 0.2 g, at least about 0.3 g, at least about 0.4 g, at least about 0.5 g, at least about 0.6 g, at least about 0.7 g, at least about 0.8 g, at least about 0.9 g, at least about 1.0 g, at least about 1.1 g, at least about 1.2 g, at least about 1.3 g, at least about 1.4 g, at least about 1.5 g, at least about 1.6 g, at least about 1.7 g, at least about 1.8 g, at least about 1.9 g, at least about 2.0 g, at least about 2.1 g, at least about 2.2 g, at least about 2.3 g, at least about 2.4 g, at least about 2.5 g, at least about 2.6 g, at least about 2.7 g, at least about 2.8 g, at least about 2.9 g, at least about 3.0 g, at least about 3.1 g, at least about 3.2 g, at least about 3.3 g, at least about 3.4 g, at least about 3.5 g, at least about 3.6 g, at least about 3.7 g, at least about 3.8 g, at least about 3.9 g, at least about 4.0 g, at least about 4.1 g, at least about 4.2 g, at least about 4.3 g, at least about 4.4 g, at least about 4.5 g, at least about 4.6 g, at least about 4.7 g, at least about 4.8 g, at least about 4.9 g, at least about 5.0 g, at least about 5.5 g, at least about 6.0 g, at least about 6.5 g, at least about 7.0 g, at least about 7.5 g, at least about 8.0 g, at least about 8.5 g, at least about 9.0 g, or at least about 9.5 g per kg of textile. When added to an aqueous bath, the compositions disclosed herein may yield an amount of EP/PO/EO triblock copolymer in the aqueous bath of at most about 9.8 g per kg of textile, such as at most about 9.5 g, at most about 9.0 g, at most about 8.5 g, at most about 8.0 g, at most about 7.5 g, at most about 7.0 g, at most about 6.5 g, at most about 6.0 g, at most about 5.5 g, at most about 5.0 g, at most about 4.9 g, at most about 4.8 g, at most about 4.7 g, at most about 4.6 g, at most about 4.5 g, at most about 4.4 g, at most about 4.3 g, at most about 4.2 g, at most about 4.1 g, at most about 4.0 g, at most about 3.9 g, at most about 3.8 g, at most about 3.7 g, at most about 3.6 g, at most about 3.5 g, at most about 3.4 g, at most about 3.3 g, at most about 3.2 g, at most about 3.1 g, at most about 3.0 g, at most about 2.9 g, at most about 2.8 g, at most about 2.7 g, at most about 2.6 g, at most about 2.5 g, at most about 2.4 g, at most about 2.3 g, at most about 2.2 g, at most about 2.1 g, at most about 2.0 g, at most about 1.9 g, at most about 1.8 g, at most about 1.7 g, at most about 1.6 g, at most about 1.5 g, at most about 1.4 g, at most about 1.3 g, at most about 1.2 g, at most about 1.1 g, at most about 1.0 g, at most about 0.9 g, at most about 0.8 g, at most about 0.7 g, at most about 0.6 g, at most about 0.5 g, at most about 0.4 g, at most about 0.3 g, at most about 0.2 g, or at most about 0.1 g per kg of textile. This includes embodiments where adding the composition to the aqueous bath yields an amount of EO/PO/EO triblock copolymer in the aqueous bath ranging from about 0.05 g per kg of textile to about 9.8 g per kg of textile, including, but not limited to, amounts ranging from about 0.5 g per kg of textile to about 9.5 g per kg of textile, from about 1.0 g per kg of textile to about 9.0 g per kg of textile, and from about 2.0 g per kg of textile to about 8.0 g per kg of textile.

When added to an aqueous bath, the compositions disclosed herein may yield an amount of aminosilicone in the aqueous bath of at least about 0.01 g per kg of textile, such as at least about 0.20 g, at least about 0.04 g, at least about 0.06 g, at least about 0.08 g, at least about 0.1 g, at least about 0.2 g, at least about 0.3 g, at least about 0.4 g, at least about 0.5 g, at least about 0.6 g, at least about 0.7 g, at least about 0.8 g, at least about 0.9, at least about 1.0 g, at least about 1.1 g, at least about 1.2 g, at least about 1.3 g, at least about 1.5 g, at least about 1.6 g, at least about 1.7 g, at least about 1.8 g, at least about 1.9 g, at least about 2.0 g, at least about 2.1 g, at least about 2.2 g, at least about 2.3 g, at least about 2.4 g, at least about 2.5 g, at least about 2.6 g, at least about 2.7 g, at least about 2.8 g, at least about 2.9 g, at least about 3.0 g, at least about 3.1 g, at least about 3.2 g, at least about 3.3 g, at least about 3.4 g, at least about 3.5 g, at least about 3.6 g, at least about 3.7 g, at least about 3.8 g, at least about 3.9 g, at least about 4.0 g, at least about 4.1 g, at least about 4.2 g, at least about 4.3 g, at least about 4.4 g, at least about 4.5 g, at least about 4.6 g, at least about 4.7 g, at least about 4.8 g, at least about 4.9 g, at least about 5.0 g, at least about 5.5 g, at least about 6.0 g, at least about 6.5 g, or at least about 7.0 g per kg of textile. When added to an aqueous bath, the compositions disclosed herein may yield an amount of aminosilicone in the aqueous bath of at most about 7.5 g per kg of textile, such as at most about 7.0 g, at most about 6.5 g, at most about 6.0 g, at most about 5.5 g, at most about 5.0 g, at most about 4.9 g, at most about 4.8 g, at most about 4.7 g, at most about 4.6 g, at most about 4.5 g, at most about 4.4 g, at most about 4.3 g, at most about 4.2 g, at most about 4.1 g, at most about 4.0 g, at most about 3.9 g, at most about 3.8 g, at most about 3.7 g, at most about 3.6 g, at most about 3.5 g, at most about 3.4 g, at most about 3.3 g, at most about 3.2 g, at most about 3.1 g, at most about 3.0 g, at most about 2.9 g, at most about 2.8 g, at most about 2.7 g, at most about 2.6 g, at most about 2.5 g, at most about 2.4 g, at most about 2.3 g, at most about 2.2 g, at most about 2.1 g, at most about 2.0 g, at most about 1.9 g, at most about 1.8 g, at most about 1.7 g, at most about 1.6 g, at most about 1.5 g, at most about 1.4 g, at most about 1.3 g, at most about 1.2 g, at most about 1.1 g, at most about 1.0 g, at most about 0.9 g, at most about 0.8 g, at most about 0.7 g, at most about 0.6 g, at most about 0.5 g, at most about 0.4 g, at most about 0.3 g, at most about 0.2 g, at most about 0.2 g, at most about 0.1 g, at most about 0.08 g, at most about 0.06 g, at most about 0.04 g, or at most about 0.02 g per kg of textile. This includes embodiments where adding the composition to the aqueous bath yields an amount of aminosilicone in the aqueous bath ranging from about 0.01 g per kg of textile to about 7.5 g per kg of textile, including, but not limited to, amounts ranging from about 0.1 g per kg of textile to about 7.5 g per kg of textile, from about 0.5 g per kg of textile to about 7.0 g per kg of textile, from about 1.0 g per kg of textile to about 6.5 g per kg of textile, and from about 2.0 g per kg of textile to about 5.5 g per kg of textile.

When added to an aqueous bath, the compositions disclosed herein may reduce the drying time of a textile after immersion in the aqueous bath by at least about 0.1% when compared to an aqueous bath wherein the EO/PO/EO block copolymer and aminosilicone are absent, such as by at least about 0.5%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, at least about 25%, at least about 26%, at least about 27%, at least about 28%, at least about 29%, or at least about 30% when compared to an aqueous bath wherein the EO/PO/EO block copolymer and aminosilicone are absent. Unless otherwise indicated, the term “drying time” means the time required to dry a textile in a tumble drying process.

When added to an aqueous bath, the compositions disclosed herein may reduce the drying time of a textile after immersion in the aqueous bath by at least about 0.1% when compared to an aqueous bath wherein the EO/PO/EO block copolymer and aminosilicone are each replaced with an equal volume of fabric softener, such as by at least about 0.5%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, or at least about 25% when compared to an aqueous bath wherein the EO/PO/EO block copolymer and aminosilicone are each replaced by an equal volume of fabric softener.

In some embodiments, the aqueous bath may be at a temperature of at least about 15° C., at least about 16° C., at least about 17° C., at least about 18° C., at least about 19° C., at least about 20° C., at least about 21° C., at least about 22° C., at least about 23° C., at least about 24° C., at least about 25° C., at least about 26° C., at least about 27° C., at least about 28° C., at least about 29° C., at least about 30° C., at least about 31° C., at least about 32° C., at least about 33° C., at least about 34° C., at least about 35° C., at least about 36° C., at least about 37° C., at least about 38° C., at least about 39° C., at least about 40° C., at least about 41° C., at least about 42° C., at least about 43° C., at least about 44° C., at least about 45° C., at least about 46° C., at least about 47° C., at least about 48° C., at least about 49° C., at least about 50° C., at least about 51° C., at least about 52° C., at least about 53° C., at least about 54° C., at least about 55° C., at least about 56° C., at least about 57° C., at least about 58° C., at least about 59° C., or at least about 60° C. In some embodiments, the aqueous bath may be at a temperature of at most about 60° C., at most about 59° C., at most about 58° C., at most about 57° C., at most about 56° C., at most about 55° C., at most about 54° C., at most about 53° C., at most about 52° C., at most about 51° C., at most about 50° C., at most about 49° C., at most about 48° C., at most about 47° C., at most about 46° C., at most about 45° C., at most about 44° C., at most about 43° C., at most about 42° C., at most about 41° C., at most about 40° C., at most about 39° C., at most about 38° C., at most about 37° C., at most about 36° C., at most about 35° C., at most about 34° C., at most about 33° C., at most about 32° C., at most about 31° C., at most about 30° C., at most about 29° C., at most about 28° C., at most about 27° C., at most about 26° C., at most about 25° C., at most about 24° C., at most about 23° C., at most about 22° C., at most about 21° C., at most about 20° C., at most about 19° C., at most about 18° C., at most about 17° C., at most about 16° C., or at most about 15° C. This includes temperatures ranging from about 15° C. to about 60° C., including but not limited to, temperatures ranging from about 20° C. to about 50° C., and from about 25° C. to about 45° C. In some embodiments, the aqueous bath may be at room temperature, which means from about 20° C. to about 25° C.

In some embodiments, the aqueous bath may have a pH of at least about 3, at least about 3.1, at least about 3.2, at least about 3.3, at least about 3.4, at least about 3.5, at least about 3.6, at least about 3.7, at least about 3.8, at least about 3.9, at least about 4.0, at least about 4.1, at least about 4.2, at least about 4.3, at least about 4.4, at least about 4.5, at least about 4.6, at least about 4.7, at least about 4.8, at least about 4.9, at least about 5.0, at least about 5.1, at least about 5.2, at least about 5.3, at least about 5.4, at least about 5.5, at least about 5.6, at least about 5.7, at least about 5.8, at least about 5.9, at least about 6.0, at least about 6.1, at least about 6.2, at least about 6.3, at least about 6.4, at least about 6.5, at least about 6.6, at least about 6.7, at least about 6.8, at least about 6.9, at least about 7.0, at least about 7.1, at least about 7.2, at least about 7.3, at least about 7.4, at least about 7.5, at least about 7.6, at least about 7.7, at least about 7.8, at least about 7.9, at least about 8.0, at least about 8.1, at least about 8.2, at least about 8.3, or at least about 8.4. In some embodiments, the aqueous bath may have a pH of at most about 8.5, at most about 8.4, at most about 8.3, at most about 8.2, at most about 8.1, at most about 8.0, at most about 7.9, at most about 7.8, at most about 7.7, at most about 7.6, at most about 7.5, at most about 7.4, at most about 7.3, at most about 7.2, at most about 7.1, at most about 7.0, at most about 6.9, at most about 6.8, at most about 6.7, at most about 6.6, at most about 6.5, at most about 6.4, at most about 6.3, at most about 6.2, at most about 6.1, at most about 6.0, at most about 5.9, at most about 5.8, at most about 5.7, at most about 5.6, at most about 5.5, at most about 5.4, at most about 5.3, at most about 5.2, at most about 5.1, at most about 5.0, at most about 4.9, at most about 4.8, at most about 4.7, at most about 4.6, at most about 4.5, at most about 4.4, at most about 4.3, at most about 4.2, at most about 4.1, at most about 4.0, at most about 3.9, at most about 3.8, at most about 3.7, at most about 3.6, at most about 3.5, at most about 3.4, at most about 3.3, at most about 3.2, or at most about 3.1. This includes embodiments where the pH values ranging from about 3 to about 8.5, including, but not limited to, values ranging from about 3.5 to about 8, and from about 4.0 to about 7.5.

A. EO/PO/EO Triblock Copolymer

The compositions disclosed herein comprise an EO/PO/EO triblock copolymer.

In some embodiments, the EO/PO/EO triblock copolymer may have a molar mass of at least about 500 g/mol, at least about 600 g/mol, at least about 700 g/mol, at least about 800 g/mol, at least about 900 g/mol, at least about 1000 g/mol, at least about 1100 g/mol, at least about 1200 g/mol, at least about 1300 g/mol, at least about 1400 g/mol, at least about 1500 g/mol, at least about 1600 g/mol, at least about 1700 g/mol, at least about 1800 g/mol, at least about 1900 g/mol, at least about 2000 g/mol, at least about 2250 g/mol, at least about 2500 g/mol, at least about 2750 g/mol, at least about 3000 g/mol, at least about 3250 g/mol, at least about 3500 g/mol, at least about 3750 g/mol, at least about 4000 g/mol, at least about 4250 g/mol, at least about 4500 g/mol, or at least about 4750 g/mol. In some embodiments, the EO/PO/EO triblock copolymer may have a molar mass of at most about 5000 g/mol, at most about 4750 g/mol, at most about 4500 g/mol, at most about 4250 g/mol, at most about 4000 g/mol, at most about 3750 g/mol, at most about 3500 g/mol, at most about 3250 g/mol, at most about 3000 g/mol, at most about 2500 g/mol, at most about 2000 g/mol, at most about 1500 g/mol, or at most about 1000 g/mol. This includes embodiments, where the EO/PO/EO triblock copolymer has a molar mass ranging from about 500 g/mol to about 5000 g/mol, including, but not limited to, molar mass ranging from about 1000 g/mol to about 4500 g/mol, and from about 1500 g/mol to about 4000 g/mol.

In some embodiments, the EO/PO/EO triblock copolymer comprises a PO block that may have a molar mass of at least about 450 g/mol, at least about 500 g/mol, at least about 600 g/mol, at least about 700 g/mol, at least about 800 g/mol, at least about 900 g/mol, at least about 1000 g/mol, at least about 1100 g/mol, at least about 1200 g/mol, at least about 1300 g/mol, at least about 1400 g/mol, at least about 1500 g/mol, at least about 1600 g/mol, at least about 1700 g/mol, at least about 1800 g/mol, at least about 1900 g/mol, at least about 2000 g/mol, at least about 2250 g/mol, at least about 2500 g/mol, at least about 2750 g/mol, at least about 3000 g/mol, at least about 3250 g/mol, at least about 3500 g/mol, at least about 3750 g/mol, at least about 4000 g/mol, or at least about 4250 g/mol. In some embodiments, the EO/PO/EO triblock copolymer comprises a PO block that may have a molar mass of at most about 4500 g/mol, at most about 4250 g/mol, at most about 4000 g/mol, at most about 3750 g/mol, at most about 3500 g/mol, at most about 3250 g/mol, at most about 3000 g/mol, at most about 2500 g/mol, at most about 2000 g/mol, at most about 1500 g/mol, at most about 1000 g/mol, at most about 750 g/mol, or at most about 500 g/mol. This includes embodiments where the EO/PO/EO triblock copolymer comprises a PO block having a molar mass ranging from about 450 g/mol to about 4500 g/mol, including, but not limited to, molar masses ranging from about 500 g/mol to about 4250 g/mol, and from about 1000 g/mol to about 4000 g/mol.

In some embodiments, the EO/PO/EO triblock copolymer may comprise at least about 1% by weight EO, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, at least about 25%, at least about 30%, at least about 35%, at least about 40%, at least about 45%, at least about 50%, at least about 55%, at least about 60%, at least about 65%, at least about 70%, at least about 75%, at least about 80%, or at least about 85% by weight EO. In some embodiments, the EO/PO/EO triblock copolymer may comprise at most about 90% by weight EO, at most about 85%, at most about 80%, at most about 75%, at most about 70%, at most about 65%, at most about 60%, at most about 55%, at most about 50%, at most about 45%, at most about 40%, at most about 35%, at most about 30%, at most about 25%, at most about 24%, at most about 23%, at most about 22%, at most about 21%, at most about 20%, at most about 19%, at most about 18%, at most about 17%, at most about 16%, at most about 15%, at most about 14%, at most about 13%, at most about 12%, at most about 11%, at most about 10%, at most about 9%, at most about 8%, at most about 7%, at most about 6%, at most about 5%, at most about 4%, at most about 3, or at most about 2% by weight EO. This includes embodiments where the EO/PO/EO triblock copolymer comprises an amount of EO by weight ranging from about 1% to about 90%, including, but not limited to, amounts ranging from about 5% to about 85%, from about 10% to about 80%, from about 15% to about 75%, and from about 20% to about 70. Preferably, the EO/PO/EO triblock copolymer comprises an amount of EO by weight ranging from about 1% to about 25%, such as from about 2% to about 20%, and from about 5% to about 15%.

Commercially available EO/PO/EO triblock copolymers suitable for use in this invention include Pluronic® PE series (available from BASF) and the Tergitol™ series (available from Dow Chemical).

B. Aminosilicone

In some embodiments, the aminosilicone may comprise cationic polydialkylsiloxanes with amino functional groups. The alkyl groups in the polydialkylsiloxanes include C1-C10 alkyl groups, such as methyl, ethyl, propyl, isopropyl, n-butyl, isobutyl, pentyl, hexyl, heptyl, octyl, nonyl, and decyl groups. For example, the aminosilicone of the present disclosure can comprise polydimthyl-, polydiethyl-, polydipropyl- or polydibutylsiloxanes with amino functional groups. Preferably, the aminosilicone comprises polydimethylsiloxane with amino functional groups.

Commercially available aminosilicones suitable for use in this invention may include Wacker® aminosilicones.

C. Fabric Softener

In some embodiments, the fabric softener may comprise any suitable fabric softener known to one of skill in the art. Suitable softener may contain 5-20% by weight cationic surfactant.

Commercially available fabric softeners suitable for use in this invention may include Clax Xtra Soft (available from Diversey, Sturtevant, Wis.).

D. Additional Components

In some embodiments, the drying aid composition may contain one or more additional components. For example, the additional components can be included to achieve a stable formulation. A stable formulation means a formulation in which no precipitation or phase separation occur during a prolonged storage period (for example, at least 3 months) at various temperatures (such as −10° C., 5° C., 20° C., 40° C., or 50° C.). The additional components may include, but are not limited to, nonionic surfactant, emulsifier, polyethylene glycol (PEG), alcoholic solvent, thickener, and preservative. Suitable nonionic surfactants may include, but are not limited to, alkylpolyethylene glycol ethers and PO/EO block polymer. Examples of commercial nonionic surfactants include Lutensol AT80 (BASF), an alkylpolyethylene glycol ethers made from a linear, saturated C16-C18 fatty alcohol and Pluronic PE10500 (BASF), and a PO/EO block polymer. Suitable emulsifiers include, but are not limited to, alcohol ethoxylates, such as Emulan HE50 (BASF). Suitable polyethylene glycols may include, but are not limited to, PEG 200 and PEG 400. Suitable alcoholic solvents may include, but are not limited to, isopropyl alcohol (IPA) and ethanol. Suitable thickeners may include, but are not limited to, cellulosic thickeners, such as carboxymethylcellulose, hydroxypropyl methylcellulose, and hydroxyethyl cellulose. Examples of commercial cellulosic thickeners include FinnFix LC (CP Kelco). Suitable preservative may include, but are not limited to, 1,2-benzisothiazolin-3-one, such as the commercial product Proxel GXL (Lonza).

### II. Uses of Compositions

The compositions described herein may be used to lower a cost of drying a textile.

In some embodiments, the cost may be reduced by at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, or at least about 25%.

In some embodiments, the cost may be reduced by reducing an energy required for drying. In some embodiments, the cost may be reduced by reducing an energy required for heating a rinse bath.

In some embodiments, the energy required for drying includes steam energy, electrical energy, and/or gas energy.

### III. Methods of Lowering a Cost of Drying a Textile

Compositions described herein may be employed in methods of lowering a cost of drying a textile. In some embodiments, the method may comprise contacting the textile with an aqueous bath containing a composition as described herein. In preferred embodiments, contacting the textile with an aqueous bath containing a composition as described herein occurs during the rinse cycle of drying a textile.

One of the principle advantages of the compositions described herein is their ability to be easily incorporated into a laundering process in order to provide cost savings. A further advantage is that the lowered cost achieved by the compositions described herein is cumulative with lowered cost achieved by improved mechanical extraction or improved energy efficiency of machinery. By providing a composition that can be incorporated into existing laundering processes, the advantages can be achieved regardless of how state-of-the-art a facility may or may not be.

In principle, the methods described herein can be applied to any method of laundering a textile that involves a rinse and dry step. In preferred embodiments, the methods described herein are applied to industrial laundering processes involving a rinse step, an extraction step, and tumble drying.

### IV. Processes for Drying a Textile

Compositions described herein may be employed in processes for laundering a textile. These processes are cost effective for at least the reasons stated above with respect to the compositions, their use and the methods of lowering a cost of drying a textile described herein.

Processes disclosed herein may comprise contacting a textile with an aqueous bath, separating the textile from the aqueous bath, and drying the textile, wherein the aqueous rinse bath comprises a composition as described herein.

In preferred embodiments, separating the textile from the aqueous bath may comprise an extraction step.

In preferred embodiments, drying the textile may comprise tumble drying.

### EXAMPLES

Exemplary embodiments of the present invention are provided in the following examples. The following examples are presented to illustrate the present invention and to assist one of ordinary skill in making and using the same. The examples are not intended in any way to otherwise limit the scope of the invention.

Use of the word linen in the Examples is intended to be illustrative of the type of textile being laundered, and not limiting the application of the compositions described herein to a particular type of textile.

As one of skill in the art would find apparent, many factors are relevant in determining the drying time, such as the external temperature and humidity conditions, fluctuations in source water temperatures, and the like. Typically, the drying tests of the present disclosure are conducted on the same day to maintain consistent conditions between the tests.

“Clax XtraSoft” or “XtraSoft” refers to Clax XtraSoft fabric softener, available commercially from Sealed Air, Duncan, S.C. “Clax Soft Conc,” “Soft Conc,” or “SoftConc” refers to Clax Soft Conc concentrated fabric softener, available commercially from Sealed Air, Duncan, S.C.

“Pluronic PE6100,” “PE6100,” or “PE61” refers to Pluronic® PE 6100 (available commercially from BASF Corporation, Florham Park, N.J.), which is a low-foaming non-ionic surfactant. PE6100 is a block copolymer having a molar mass of about 1750 g/mol, about 10% EO in molecule, and a density of approximately 1.02 g/mL at 23° C.

“Wacker FC204” or “FC204” refers to Wacker® FC 204 (available commercially from Wacker Chemie AG, Munich, Germany), a composition containing a self-dispersing aminofunctional silicone fluid, having approximately 20% aminosilicone, and a density of approximately 1 g/mL at 20° C. “Wacker 2036M6” or “2036M6” refers to Wacker® 2036M6 (Wacker Chemie AG, Munich, Germany), a composition containing a self-dispersing aminofunctional silicone fluid, having approximately 15% aminosilicone, and a density of approximately 1 g/mL at 20° C.

“Tergitol L-61” or “L-61” refers to Tergitol™ L-61 (Dow Chemical Company, Midland, Mich.) nonionic surfactant, a polyether polyol. Tergitol L-61 has a density at 25° C. of about 1.015 g/mL.

### Example 1. Reduced Drying Time

About 10 kg of standard 630 GSM 100% cotton terry towels were run through a rinse cycle in an 11 kg Unimac® washer-extractor and tumble dried in an electrically heated 10 kg Primus tumble dryer. Compositions were evaluated by determining the percent water retention in the towels after final extraction and/or drying time in the tumble dryer. The percent water retention is calculated by the following equation:

$$\% W = \frac{{w}_{w} - {w}_{i}}{{w}_{i}} \times 100 \qquad ( 1 )$$

wherein % W is the percent water retention, w_{w} is the weight of the wet towels after final spinning, hydro-extraction or drying time in the tumble dryer, and wᵢ is the initial weight of the dry towels kept in a conditioning room at 20° C. and 55-60% relative humidity for 24 hours.

A rinse cycle and tumble drying were performed on the towels with no additive and with 8 ml of Clax XtraSoft per kg of towel (˜80 ml of Clax XtraSoft). These two experiments were performed on the same day. The results with no additive yielded a 61.25% water retention after the final spin extraction and 65 minutes of tumble drying were required to achieve 0% water retention. The results with 8 mL of Clax XtraSoft per kg of towel as additive yielded a 57.20% water retention after the final spin extraction and 61 minutes of tumble drying were required to achieve 0% water retention. This establishes that adding a fabric softener to a rinse cycle can reduce drying time. From this point forward, the reduction in drying time that was achieved by adding a fabric softener was considered to be the reference for comparison.

The compositions of Table 1 were introduced as an additive to the rinse cycle and tumble drying described in this Example, and the experiments were performed on the same day. The percent water retention after extraction, the tumble drying time required to achieve 0% water retention and corresponding percent reduction in drying time when compared with the control are also reported in Table 1.

TABLE 1

| | Components (in mL per kg of | | | | Tumble | |
|---|---|---|---|---|---|---|
| | textile) | | | % W After | Drying Time | Reduction in |
| Composition | SoftConc | FC204 | PE6100 | Extraction | (min) | Drying Time |
| Control 1 | 3 | 0 | 0 | 65.77 | 55 | n/a |
| Comparative | 3 | 1 | 0 | 63.64 | 52 | 6% |
| Example 1A | | | | | | |
| Comparative | 3 | 2 | 0 | 65.00 | 52 | 6% |
| Example 1B | | | | | | |
| Comparative | 3 | 0 | 1 | 66.29 | 56 | −2% |
| Example 1C | | | | | | |
| Comparative | 3 | 0 | 2 | 64.08 | 54 | 2% |
| Example 1D | | | | | | |
| Example 1 | 3 | 1 | 1 | 62.44 | 50 | 10% |

The data show that addition of 2 mL per kg of FC204 provides modest reduction in drying time and addition of 2 mL per kg of PE6100 provides somewhat less reduction in drying time, if any. However, when they are used together, addition of 1 mL per kg of FC204 and 1 mL per kg of PE6100 provides reduction in drying time that exceeds the reduction achieved by either component used alone.

### Example 2. Industrial Scale Reduced Drying Time

About 92 kg of bath linen containing bath towels, hand towels, face towels, bath mats and bath robes was run through a wash and rinse cycle in a Manor® 42022 WP2 divided-cylinder washer-extractor, with max speed of 735 rpm and hydro-extraction at 300 G-force. After extraction, about 46 kg of bath linen was loaded into a steam-heated Tumble Dryer ADC 120 (American Dryer Corp., Fall River, Mass.) with 54.43 kg capacity, 204.12 kg/hour steam consumption and air flow of 55.22 cmm.

The compositions of Table 2 were introduced as an additive to the rinse cycle and tumble drying described in this Example, and the experiments were performed on the same day. The tumble drying time required to achieve 0% water retention and corresponding percent reduction in drying time when compared with the control are also reported in Table 2. The experiment was repeated 8 times for the control composition and at least 2 times for the other compositions, and the results were averaged.

TABLE 2

| | Components | | | Tumble | Reduction |
|---|---|---|---|---|---|
| | (in mL per kg of textile) | | | Drying | in Drying |
| Composition | SoftConc | FC204 | PE6100 | Time (min) | Time |
| Control 2 | 5 | 0 | 0 | 48.5 | n/a |
| Comparative | 8 | 0 | 0 | 47 | 3.09% |
| Example 2A | | | | | |
| Comparative | 5 | 2 | 0 | 42 | 13.40% |
| Example 2B | | | | | |
| Comparative | 5 | 0 | 2 | 40 | 17.53% |
| Example 2C | | | | | |
| Example 2A | 5 | 1 | 1 | 38 | 21.65% |
| Example 2B | 5 | 1 | 2 | 36 | 25.77% |

The data show that addition of 2 mL per kg of FC204 and 2 mL per kg of PE6100 each provide modest reduction in drying time. However, when they are used together, addition of 1 mL per kg of FC204 and 1 or 2 mL per kg of PE6100 provides reduction in drying time that far exceeds the reduction achieved by either component used alone.

In a separate experiment, similar compositions were run through the same wash, rinse and dry cycle as described above, with the temperature of the rinse bath raised from 25° C. to 45° C. These experiments were performed on the same day. The results are shown in Table 3.

TABLE 3

| | Tumble Drying | Tumble Drying | Reduction |
|---|---|---|---|
| | Time for Rinse at | Time for Rinse at | in Drying |
| Composition | 25° C. (min) | 45° C. (min) | Time |
| Control 2 | 48 | 42 | 12.50% |
| Comparative | 42 | 36 | 14.29% |
| Example 2B | | | |
| Comparative | 40 | 35 | 12.50% |
| Example 2C | | | |
| Example 2A | 38 | 34 | 10.53% |
| Example 2B | 36 | 34 | 5.56% |

### Example 3. Comparing Active Ingredients

About 52 kg of bath linen containing bath towels, hand towels, face towels, bath mats and bath robes was run through a wash and rinse cycle in a Manor® 42026 XJ7 one-cylinder washer-extractor, with a max speed of 709 rpm and hydro-extraction at 285 G-force. After extraction, about 52 kg of bath linen was loaded into a steam-heated Tumble Dryer ADC 170 (American Dryer Corp., Fall River, Mass.) with 54.43 kg capacity, 210.92 kg/hour steam consumption and air flow of 124.59 cmm.

The compositions of Table 4 were introduced as an additive to the rinse cycle and tumble drying described in this Example, and the experiments were performed on the same day. The tumble drying time required to achieve 0% water retention and corresponding percent reduction in drying time when compared with the control are also reported in Table 4. The experiment was repeated eight times for the control composition and at least three times for the other compositions, and the results were averaged.

TABLE 4

| | Components (in mL per kg of textile) | | | | | Drying time | Reduction in Drying |
|---|---|---|---|---|---|---|---|
| Composition | XtraSoft | FC204 | 2036M6 | PE61 | L-61 | (min) | Time |
| Control | 9.5 | 0 | 0 | 0 | 0 | 52.5 | n/a |
| Example 3A | 9.5 | 0.5 | 0 | 1.5 | 0 | 43.5 | 17.14% |
| Example 3B | 9.5 | 1.0 | 0 | 1.0 | 0 | 45.5 | 13.33% |
| Example 3C | 9.5 | 0.25 | 0 | 1.0 | 0 | 46.5 | 11.43% |
| Example 3D | 9.5 | 0 | 1.0 | 1.0 | 0 | 43.5 | 17.14% |
| Example 3E | 9.5 | 0 | 0.5 | 0 | 1.5 | 42.5 | 19.05% |

The data indicate that there may be an advantage to using slightly more EO/PO/EO triblock copolymer than aminosilicone. In particular, a 3:1 ratio appears to provide superior reduction in drying time when compared with a 1:1 ratio.

### Example 4. Dosage of Drying Aid

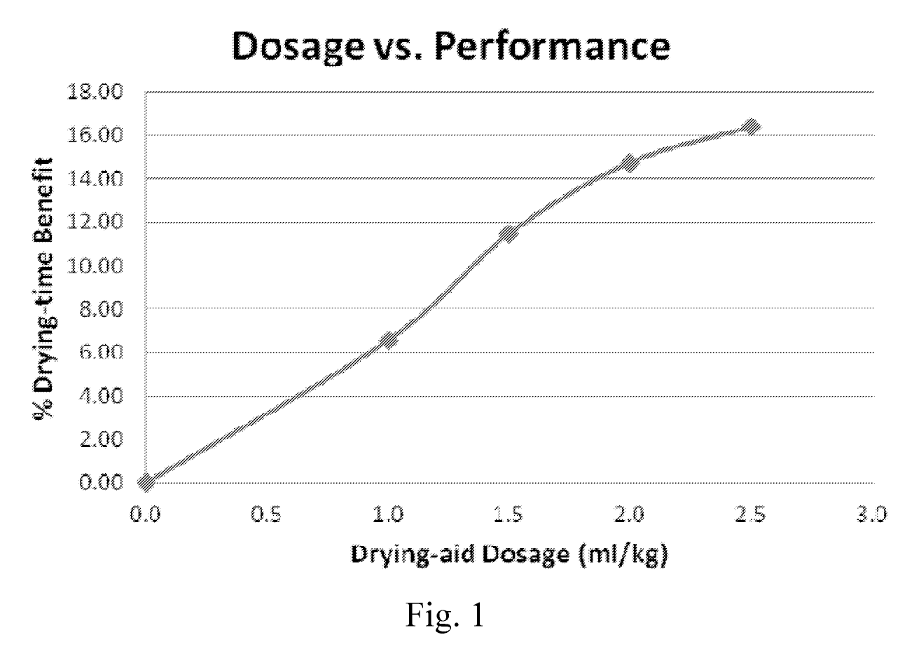

The drying aid compositions of Example 4 contained a 3:1 ratio of Pluronic 6100 to Wacker 2036M6. Following the procedure of Example 3, the effect of varying the dosage of the drying aid composition was studied by adding 9.5 mL of XtraSoft per kg of linen and a dosage of the drying aid composition containing the 3:1 ratio of active ingredients as indicated in Table 5. The tumble drying time required to achieve 0% water retention was reduced when compared with the 0 mL/kg dosage. The data of Table 5 are graphed in FIG. 1.

TABLE 5

| | | Reduction |
|---|---|---|
| Dosage | Drying | in Drying |
| (mL/kg) | Time (min) | Time (min) |
| 0.0 | 61 | n/a |
| 1.0 | 57 | 6.56 |
| 1.5 | 54 | 11.48 |
| 2.0 | 52 | 14.75 |
| 2.5 | 51 | 16.39 |

### Example 5. Drying Aid Compositions

Several drying aid compositions were prepared and their effect in reducing drying time evaluated according to the process described in the above Examples. As shown in Table 6 (all components are expressed in weight %), these compositions contained different amounts of Pluronic PE6100 (100% EO/PO/EO block polymer) and Wacker FC204 (25% aminosilicone). The combined amount of Pluronic PE6100 and Wacker FC204 were maintained at 75% by weight of the tested compositions. Additional components were used to achieve a stabilized composition, including Lutensol AT80 (BASF), an alkylpolyethylene glycol ethers made from a linear, saturated C16-C18 fatty alcohol; Emulan HE50 (BASF), an alcohol ethoxylate; Pluronic PE10500 (BASF), a PO/EO block polymer; poly(ethylene glycol), including PEG 200 and PEG 400; isopropyl alcohol (IPA); carboxymethylcellulose, such as FinnFix LC (CP Kelco); sodium chloride; Proxel GXL (Lonza), an aqueous solution of 1,2-benzisothiazolin-3-one and dipropylene glycol; and the balance of water.

TABLE 6

| Raw material | Composition 1 | Composition 2 | Composition 3 | Composition 4 | Composition 5 | Composition 6 |
|---|---|---|---|---|---|---|
| Pluronic | 50 | 53.72 | 68 | 7 | 75 | 0 |
| PE6100 (BASF) | | | | | | |
| Wacker FC204 | 25 | 25 | 7 | 68 | 0 | 75 |
| (Wacker) | | | | | | |
| Lutensol AT80 | 5 | 0 | 0.05 | 10 | 5 | 5 |
| (BASF) | | | | | | |
| Emulan HE50 | 0 | 0 | 18.5 | 10 | 0 | 0 |
| (BASF) | | | | | | |
| Pluronic | 0 | 3 | 0 | 0 | 0 | 0 |
| PE10500 | | | | | | |
| (BASF) | | | | | | |
| PEG200 | 7.9 | 9 | 6.37 | 4.92 | 7.9 | 7.9 |
| PEG400 | 0 | 9 | 0 | 0 | 0 | 0 |
| Water | 5 | 0 | 0 | 0 | 5 | 5 |
| IPA | 5 | 0 | 0 | 0 | 5 | 5 |
| Finnfix LC | 0 | 0.2 | 0 | 0 | 0 | 0 |
| (CP Kelco) | | | | | | |
| Sodium | 2 | 0 | 0 | 0 | 2 | 2 |
| Chloride | | | | | | |
| Proxel GXL | 0.1 | 0.08 | 0.08 | 0.08 | 0.1 | 0.1 |
| (Lonza) | | | | | | |
| Total | 100 | 100 | 100 | 100 | 100 | 100 |
| Reduction in | 10.9 | 14.6 | 3.9 | 6.1 | 4.2 | 7.7 |
| drying time % | | | | | | |
| Standard | 1.2 | 2.7 | 1.5 | 2.4 | 1.7 | 0.2 |
| deviation % | | | | | | |

The data in Table 6 shows that the synergistic effect of the combination of EO/PO/EO block polymer (Pluronic PE6100, 100% active) and aminosilicone (Wacker FC204, 25% active) in reducing drying time of the textile extends to a range of EO/PO/EO block polymer to aminosilicone weight ratios, for example, from about 40:1 (composition 3) to about 0.4:1 (composition 4).

What is claimed is:

1-33. (canceled)

34. A process for laundering a textile, the process comprising:
A) contacting a textile with an aqueous bath;
B) separating the textile from the aqueous bath; and
C) drying the textile,
wherein the aqueous bath comprises from about 0.05 g to about 10 g of an ethylene oxide-propylene oxide-ethylene oxide (EO/PO/EO) triblock copolymer per kg of textile;
and about 0.01 g to about 7.5 g of an aminosilicone per kg of textile.

35. The process of claim 34, wherein the EO/PO/EO triblock copolymer has a molar mass of from about 500 g/mol to about 5000 g/mol.

36. The process of claim 34, wherein the EO/PO/EO triblock copolymer comprises a PO block having a molar mass of from about 450 g/mol to about 4500 g/mol.

37. The process of claim 34, wherein the EO/PO/EO triblock copolymer comprises from about 1% by weight to about 25% by weight EO.

38. The process of claim 34, wherein the aminosilicone comprises a polydimethylsiloxane with amino functional groups.

39. The process of claim 34, wherein separating the textile from the aqueous bath comprises an extraction step.

40. The process of claim 34, wherein drying the textile comprises tumble drying.

41. The process of claim 34, wherein the aqueous bath is at a temperature of about room temperature.

42. The process of claim 34, wherein the aqueous bath is at a temperature from about 15° C. to about 60° C.

43. The process of claim 34, wherein the aqueous bath has a pH from about 3 to about 8.5.
